(19) United States
(12) Patent Application Publication
(10) Pub. No.: US 2015/0115841 A1
(43) Pub. Date: Apr. 30, 2015

(54) METHOD AND APPARATUS FOR PRODUCING SITUATIONAL ACOUSTO-OPTIC EFFECT

(71) Applicant: Wistron Corporation, New Taipei City (TW)

(72) Inventors: Wen-Chin Wu, New Taipei City (TW); Yi-Sheng Kao, New Taipei City (TW)

(73) Assignee: Wistron Corporation, New Taipei City (TW)

(21) Appl. No.: 14/249,353

(22) Filed: Apr. 10, 2014

(30) Foreign Application Priority Data
Oct. 30, 2013 (TW) 102139359

(51) Int. Cl. H05B 37/02

(52) U.S. Cl. CPC H05B 37/0236
USPC 315/307

(57) ABSTRACT

A method and an apparatus for producing situational acousto-optic effect are provided. In the method, a sound signal is detected and a fast Fourier transform (FFT) and a normalization calculation are performed on the sound signal to produce a frequency domain signal. Then, a plurality of frequencies having variations between the frequency domain signals produced before and after a time point are determined whether to fit in with a frequency spectrum of a specific tone. Once the frequencies fit in with the frequency spectrum, a light source is controlled to produce light with a color corresponding to the specific tone.

### CROSS-REFERENCE TO RELATED APPLICATION

This application claims the priority benefit of Taiwan application serial no. 102139359, filed on Oct. 30, 2013. The entirety of the above-mentioned patent application is hereby incorporated by reference herein and made a part of this specification.

### BACKGROUND

1. Technical Field

The invention relates to a method and an apparatus for producing acousto-optic effect. Particularly, the invention relates to a method and an apparatus for producing situational acousto-optic effect.

2. Related Art

As a size of a current household television becomes larger, and a thickness thereof becomes thinner, under limitation of the appearance, acoustic performance of the television is sacrificed. Therefore, a single speaker or a home theatre composed of a plurality of surrounding speakers is added to the periphery of the television to meet the increasing demand on the acoustic performance of the television.

In order to increase market distinctiveness, the conventional speakers are generally added with additional designs of lighting, water column, etc. to increase a situational effect. However, in view of the existing market, the lighting effect of the speaker products are generally limited to the speaker itself, and a range of the created atmosphere is limited. If the speaker is a portable product, it further has a disadvantage of increased power consumption. Moreover, if the lighting effect, the water column effect, etc. are added to the single speaker, since the speaker is disposed aside the television, the user may have a visual disturbance when watching the television due to a direct look at the light source.

### SUMMARY

The invention is directed to a method and an apparatus for producing situational acousto-optic effect, which are capable of interpreting sound content to produce a suitable situational light.

The invention provides a method for producing situational acousto-optic effect, which is adapted to an electronic apparatus. In the method, a sound signal is detected and a fast Fourier transform and a normalization calculation are performed on the sound signal to produce a frequency domain signal. Then, it is determined whether a plurality of frequencies having variations between the frequency domain signals produced before and after a time point fit in with a frequency spectrum of a specific tone. Once the frequencies fit in with the frequency spectrum of the specific tone, a light source is controlled to produce light with a color corresponding to the specific tone.

In an embodiment of the invention, the step of determining whether the frequencies having variations between the frequency domain signals produced before and after the time point fit in with the frequency spectrum of the specific tone includes following steps. The frequencies having the variations are respectively compared with a plurality of characteristic frequencies in the frequency spectrum of each of a plurality of tones, and when the frequencies exactly fit in with the characteristic frequencies in the frequency spectrum of the specific tone, it is determined that the frequencies fit in with the frequency spectrum of the specific tone.

In an embodiment of the invention, when the frequencies fit in with the frequency spectrum of the specific tone, the method further includes following steps. The sound signal is continually detected. The fast Fourier transform and the normalization calculation are performed on the sound signal to produce the frequency domain signal. Then, it is determined whether a plurality of frequencies having variations between the frequency domain signals produced before and after a next time point fit in with the frequency spectrum of another specific tone. Once the frequencies fit in with the frequency spectrum of the another specific tone, the light source is controlled to produce the light with a color corresponding to the another specific tone.

In an embodiment of the invention, after the step of controlling the light source to produce the light with a color corresponding to the another specific tone, the method further includes controlling the light produced by the light source to transform between the color corresponding to the specific tone and the color corresponding to the another specific tone when each waveform of the sound signal reaches a peak.

The invention provides a method for producing situational acousto-optic effect, which is adapted to an electronic apparatus. In the method, a sound signal is detected, and it is determined whether a characteristic value of a plurality of waveforms of the sound signal reaches a predetermined value, and when the characteristic value of the waveforms reaches the predetermined value, the light source is controlled to produce light with a color corresponding to the predetermined value.

In an embodiment of the invention, the characteristic value is an oscillation frequency of the waveforms, and before the step of determining whether the characteristic value of the waveforms reaches the predetermined value, the method further includes following steps. A maximum value and a minimum value of the characteristic value of the waveforms of the sound signal are detected, and a section between the minimum value and the maximum value is divided into a plurality of predetermined values, and a corresponding color of the light is set for each of the predetermined values.

In an embodiment of the invention, the step of dividing the section between the minimum value and the maximum value into the predetermined values and setting the corresponding color of the light for each of the predetermined values includes following steps. The color of the light corresponding to the minimum value is set to purple, the color of the light corresponding to the maximum value is set to red, and the color of the light corresponding to each of the predetermined values in the section between the minimum value and the maximum value is sequentially set to other colors between purple and red.

In an embodiment of the invention, the characteristic value is an amplitude of each of the waveforms, and the step of determining whether the characteristic value of the waveforms of the sound signal reaches the predetermined value, so as to control the light source to produce the light with the color corresponding to the predetermined value comprises following steps. It is determined whether the characteristic value of each waveform of the sound signal reaches a peak. The light source is controlled to transform the color of the light when the characteristic value of each waveform of the sound signal reaches the peak.

The invention provides an apparatus for producing situational acousto-optic effect, which includes a sound detection module, a signal transformation module, a determination module and a light control module. The sound detection module is used for detecting a sound signal. The signal transformation module is used for performing a fast Fourier transform and a normalization calculation on the sound signal detected by the sound detection module to produce a frequency domain signal. The determination module is used for determining whether a plurality of frequencies having variations between the frequency domain signals produced before and after a time point fit in with a frequency spectrum of a specific tone. The light control module controls a light source to produce light with a color corresponding to the specific tone when the determination module determines that the frequencies fit in with the frequency spectrum of the specific tone.

In an embodiment of the invention, the determination module respectively compares the frequencies having the variations with a plurality of characteristic frequencies in the frequency spectrum of a plurality of tones, and when the frequencies exactly fit in with the characteristic frequencies in the frequency spectrum of the specific tone, the determination module determines that the frequencies fit in with the frequency spectrum of the specific tone.

In an embodiment of the invention, the determination module determines whether a plurality of frequencies having variations between the frequency domain signals produced before and after a next time point fit in with the frequency spectrum of another specific tone, and when the determination module determines that the frequencies fit in with the frequency spectrum of the another specific tone, the light control module controls the light source to produce the light with a color corresponding to the another specific tone.

In an embodiment of the invention, the light control module further controls the light produced by the light source to transform between the color corresponding to the specific tone and the color corresponding to the another specific tone when each waveform of the sound signal reaches a peak.

The invention provides an apparatus for producing situational acousto-optic effect, which includes a sound detection module, a determination module and a light control module. The sound detection module detects a sound signal. The determination module determines whether a characteristic value of a plurality of waveforms of the sound signal reaches a predetermined value. The light control module controls the light source to produce light with a color corresponding to the predetermined value when the determination module determines that the characteristic value of the waveforms reaches the predetermined value.

In an embodiment of the invention, the characteristic value is an oscillation frequency of the waveforms, and the apparatus further includes a color setting module, and the color setting module detects a maximum value and a minimum value of the characteristic value of the waveforms of the sound signal, and divides a section between the minimum value and the maximum value into a plurality of predetermined values, and sets a corresponding color of the light for each of the predetermined values.

In an embodiment of the invention, the color setting module sets the color of the light corresponding to the minimum value to purple, sets the color of the light corresponding to the maximum value to red, and sequentially sets the color of the light corresponding to each of the predetermined values in the section between the minimum value and the maximum value to other colors between purple and red.

In an embodiment of the invention, the characteristic value is an amplitude of each of the waveforms, and the determination module determines whether the characteristic value of each waveform of the sound signal reaches a peak, and the light control module controls the light source to transform the color of the light when the determination module determines that the characteristic value of each waveform of the sound signal reaches the peak.

In an embodiment of the invention, the specific tone includes a tone of a sound producing object, and the sound producing object comprises a human, an animal, or a musical instrument.

According to the above descriptions, in the method and apparatus for producing situational acousto-optic effect, the sound signal is transformed into a frequency domain signal, and the frequencies having variations in the frequency domain signals are compared with the frequency spectrums of a plurality of tones, so as to recognize the tone carried by the sound signal, and accordingly produce the corresponding situational light. Moreover, the color of the produced light is suitably transformed according to frequency variation and cadence of the sound signal, so as to provide a harmonized acousto-optic effect.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus for producing situational acousto-optic effect according to an embodiment of the invention.

FIG. 2 is a flowchart illustrating a method for producing situational acousto-optic effect according to an embodiment of the invention.

FIG. 3 is a waveform diagram of a sound signal according to an embodiment of the invention.

FIG. 4 is a flowchart illustrating a method for producing situational acousto-optic effect according to an embodiment of the invention.

FIG. 5 is a waveform diagram of a sound signal according to an embodiment of the invention.

FIG. 6 is a block diagram of an apparatus for producing situational acousto-optic effect according to an embodiment of the invention.

FIG. 7 is a flowchart illustrating a method for producing situational acousto-optic effect according to an embodiment of the invention.

FIG. 8 is a waveform diagram of a sound signal according to an embodiment of the invention.

### DETAILED DESCRIPTION OF DISCLOSED EMBODIMENTS

In the invention, by analysing a rhythm and frequency of a sound signal and comparing the same with frequency spectrums of a plurality of tones, different tones carried by the sound signal are determined to find situational characteristics hidden in the sound signal. According to the situational characteristics, the color of the light produced by the light source and a timing of transforming the color of the light are controlled to produce the color of light corresponding to a sound situation, so as to provide an acousto-optic effect with sound and light harmonized to each other.

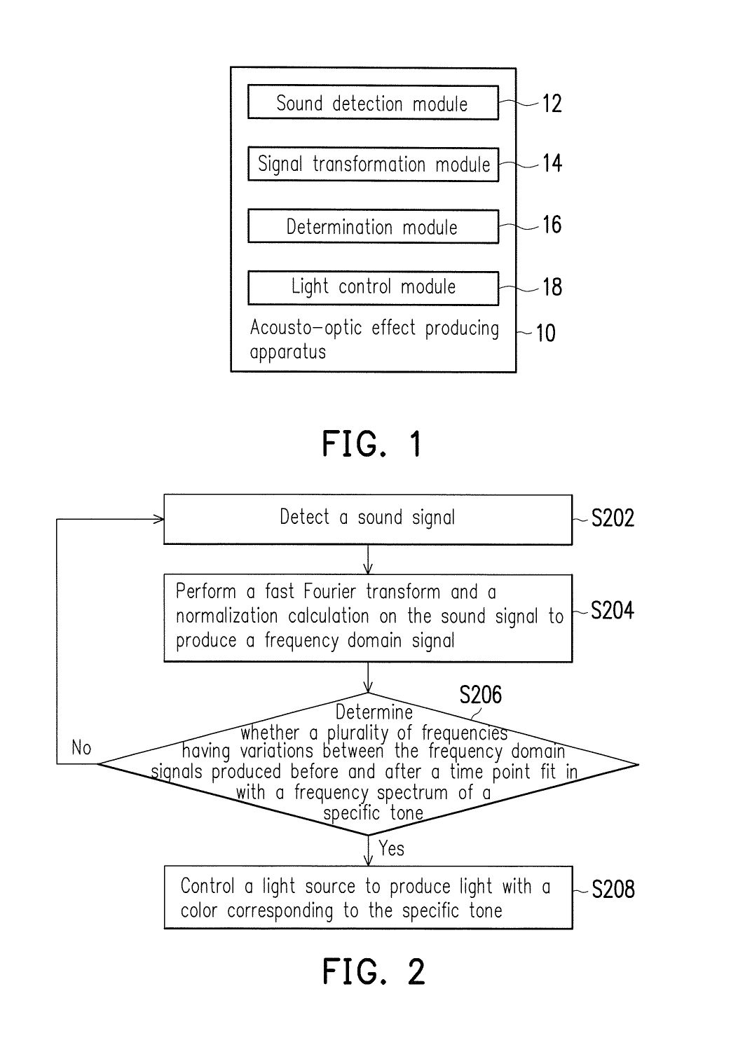

FIG. 1 is a block diagram of an apparatus for producing situational acousto-optic effect according to an embodiment of the invention. Referring to FIG. 1, the acousto-optic effect producing apparatus 10 is, for example, an electronic apparatus having a basic computing capability such as a mobile phone, a tablet PC, a notebook computer, a video player, or a sound system. The acousto-optic effect producing apparatus 10 includes a sound detection module 12, a signal transformation module 14, a determination module 16 and a light control module 18. The aforementioned modules are, for example, hardware devices composed of logic circuit elements, and are capable of executing a function of producing the situational acousto-optic effect. The aforementioned modules can also be programs stored in a storage medium of the electronic apparatus, and the programs can be loaded to a processor of the electronic apparatus to execute the function of producing the situational acousto-optic effect.

FIG. 2 is a flowchart illustrating a method for producing situational acousto-optic effect according to an embodiment of the invention. Referring to FIG. 1 and FIG. 2, the method of the present embodiment is adapted to the acousto-optic effect producing apparatus 10, and detailed steps of the method of the present embodiment are described below with reference of various components of the acousto-optic effect producing apparatus 10 of FIG. 1.

First, the sound detection module 12 detects a sound signal (step S202), where the sound detection module 12, for example, detects an ambient sound of the acousto-optic effect producing apparatus 10 by using a microphone of the acousto-optic effect producing apparatus 10 to produce the sound signal.

Then, the signal transformation module 14 executes a fast Fourier transform and a normalization calculation on the sound signal detected by the sound detection module 12 to produce a frequency domain signal (step S204). In the present embodiment, by observing a variation of the frequency domain signal, a specific frequency having a large variation in the sound signal is obtained, so as to determine a tone carried by the sound signal.

In detail, based on the aforementioned frequency domain signal, the determination module 16 obtains a plurality of frequencies having variations between the frequency domain signals produced by the signal transformation module 14 before and after a time point, and compares the same with frequency spectrums of a plurality of tones to determine whether the frequencies fit in with the frequency spectrum of a specific tone (step S206). Since the normalized frequency domain signal may represent a reference value of the sound signal at a certain time point, once the sound signal after such time point has a large variation relative to the reference value, it is determined that a sound producing object with the specific tone is appeared in the sound signal. Frequency spectrums of the tones of different sound producing objects can be obtained in advance through pre-analysis, such that when the frequencies having variations in the current sound signal are obtained, by comparing the frequencies with frequencies in the frequency spectrum of a plurality of tones, it can be determined whether the sound producing object with the specific tone is appeared in the sound signal. The sound producing object comprises a human, an animal, or a musical instrument, and is not limited herein. In detail, when the comparison is performed, the determination module 16, for example, respectively compares the frequencies having the variations with a plurality of characteristic frequencies in the frequency spectrum of a plurality of tones, and when the frequencies exactly fit in with the characteristic frequencies in the frequency spectrum of the specific tone, it can be determined that the frequencies fit in with the frequency spectrum of the specific tone.

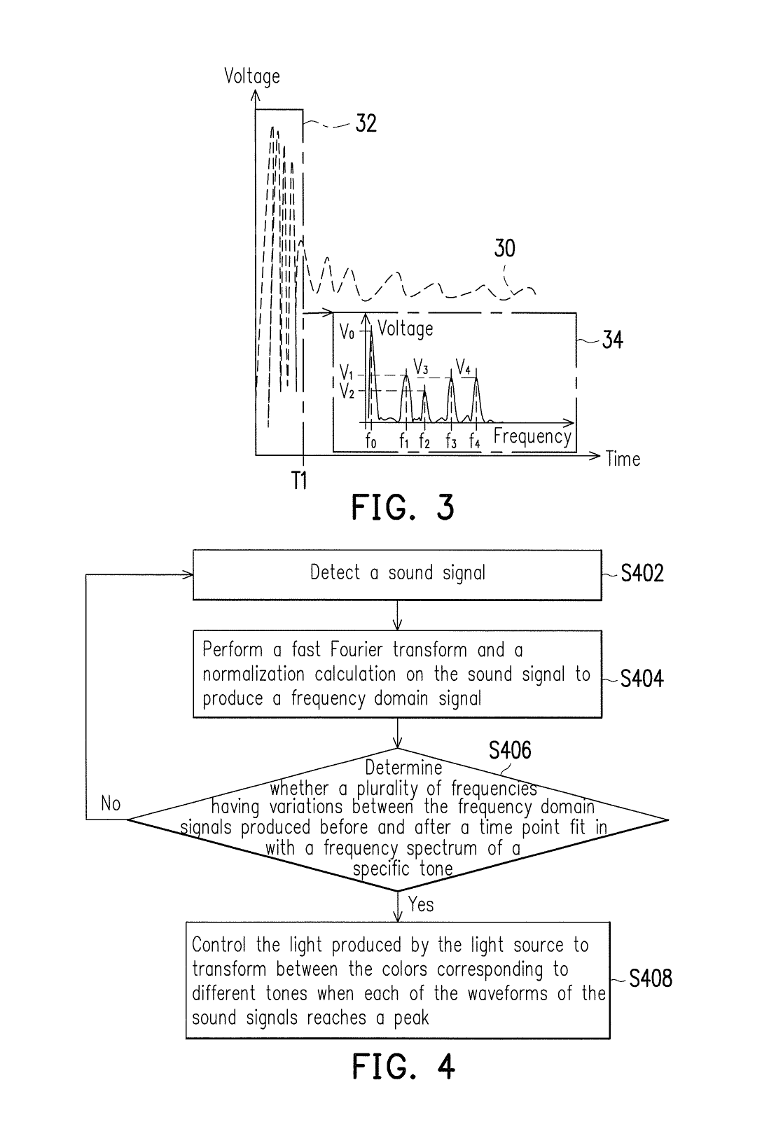

For example, FIG. 3 is a waveform diagram of a sound signal according to an embodiment of the invention. Referring to FIG. 3, in the waveform diagram of the sound signal 30 of the present embodiment, a horizontal axis represents time, and a vertical axis represents voltages obtained by a microphone when measuring the sound signal 30, which reflects an intensity of the sound signal 30. In the present embodiment, the fast Fourier transform is executed on a partial sound signal 32 before a time point T1 to obtain a frequency spectrum 34 of the partial sound signal 32. The frequency spectrum 34 includes a plurality of frequencies having variations (for example, frequencies f⁰, f₁, f₂, f₃, f₄) and a plurality of voltages (for example, voltages v₀, v₁, v₂, v₃, v₄) measured corresponding to the above frequencies. By comparing the frequency spectrum 34 with spectrums of a plurality of tones (or music instruments), the specific tone carried by the sound signal 30 can be found.

Referring back to the flow of FIG. 2, when the determination module 16 determines that the frequencies do not fit in with the frequency spectrum of the specific tone, the flow returns to the step S202, and the sound detecting module 12 continually detects the sound signal to analyze the tone carried by the sound signal. When the determination module 16 determines that the frequencies fit in with the frequency spectrum of the specific tone, the light control module 18 controls a light source to produce light with a color corresponding to the specific tone (step S208). The light control module 18 is, for example, coupled to a plurality of light sources configured at periphery of a television through a wired manner or a wireless manner, and controls the light sources to produce light with a color corresponding to the specific tone in the sound signal according to a determination result of the determination module 16.

It should be noticed that, in an embodiment, the acousto-optic effect producing apparatus 10 may pre-establish frequency spectrums of musical instruments such as guitar, piano, violin, French horn, trumpet, saxophone, or bass, and provide the same to the determination module 16 for determining the tones. Moreover, the acousto-optic effect producing apparatus 10 can also set a color corresponding to each of the tones according to strengths of the tones of the musical instruments, and the light control module 18 controls the light source to produce light with the corresponding color according to the above setting. For example, guitar, piano, violin, French horn, trumpet, saxophone and bass respectively correspond to red, orange, yellow, green, blue, indigo and purple, and when the determination module 16 determines that the frequency fits in with the tone of a certain musical instrument, the light control module 18 controls the light sources to produce light with a color corresponding to such musical instrument (tone).

According to the above method, different tones produced by different sound producing objects and carried by the sound signal can be detected, so as to produce light with a color corresponding to such tone, and provide an acousto-optic effect with sound and light harmonized to each other.

It should be noticed that in another embodiment, after the acousto-optic effect producing apparatus 10 determines the specific tone from the sound signal, it is continually detected whether the sound signal carries other tones, and if it is discovered that the sound signal carries a plurality of tones, the light produced by the light source is controlled to transform between the colors corresponding to the tones, such that the produced light can reflect emotion of the tones.

In detail, FIG. 4 is a flowchart illustrating a method for producing situational acousto-optic effect according to an embodiment of the invention. Referring to FIG. 1 and FIG. 2, the method of the present embodiment is adapted to the acousto-optic effect producing apparatus 10, and detailed steps of the method of the present embodiment are described below with reference of various components of the acousto-optic effect producing apparatus 10 of FIG. 1.

First, the sound detection module 12 detects a sound signal (step S402). Then, the signal transformation module 14 executes a fast Fourier transform and a normalization calculation on the sound signal detected by the sound detection module 12 to produce a frequency domain signal (step S404). Thereafter, the determination module 16 obtains a plurality of frequencies having variations between the frequency domain signals produced by the signal transformation module 14 before and after a time point, and compares the same with frequency spectrums of a plurality of tones so as to determine whether the frequencies fit in with the frequency spectrum of a specific tone (step S406). When the determination module 16 determines that the frequencies do not fit in with the frequency spectrum of the specific tone, the flow returns to the step S402, and the sound detecting module 12 continually detects the sound signal to analyze the tone carried by the sound signal. The above steps S402-S406 are the same as or similar to the steps S202-S206 of the aforementioned embodiment, and therefore details thereof are not repeated.

A difference between the present embodiment and the aforementioned embodiment lies in that, in the present embodiment, when the determination module 16 determines that the frequencies fit in with the frequency spectrum of the specific tone, the light control module 18 first controls the light source to produce light with a color corresponding to the specific tone, and while the light source is controlled to produce the light, the flow returns back to the step S402, by which the sound detection module 12 continually detects the sound signal, and the signal transformation module 14 transforms the same into the frequency domain signal, and the determination module 16 determines whether a plurality of frequencies having variations between the frequency domain signals produced before and after a next time point fit in with a frequency spectrum of another specific tone, and when the determination module 16 determines another tone from the frequency domain signal, the light control module 18 controls the light produced by the light source to transform between the colors corresponding to the tones when each waveform of the sound signal reaches a peak (step S408). Since human eyes are sensitive to color variations of light, by transforming the colors of the light when the sound signal reaches the peak, emotions of different tones are presented, which increases a feeling of the user on the sound effect.

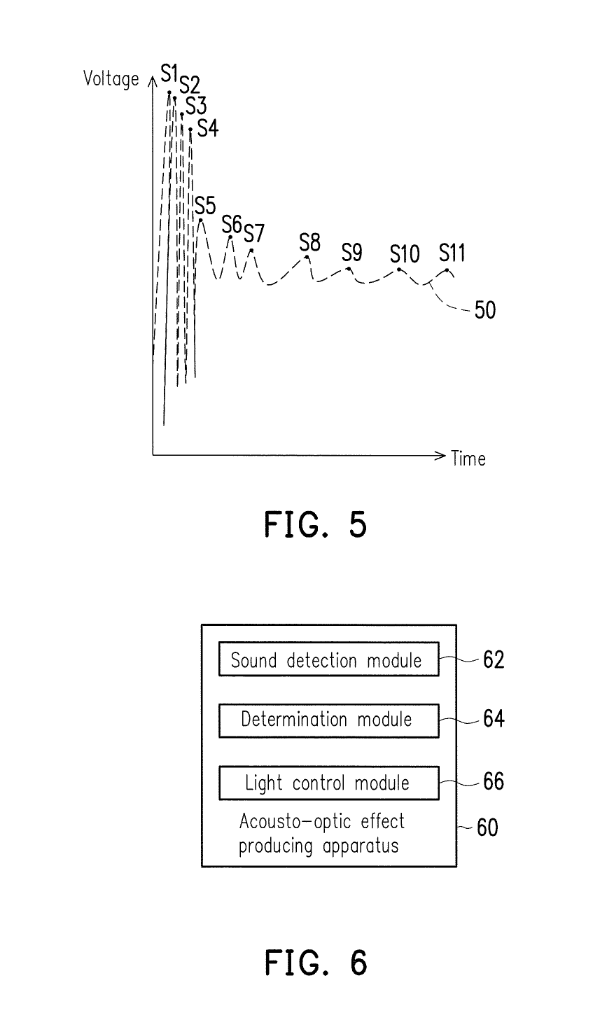

For example, FIG. 5 is a waveform diagram of a sound signal according to an embodiment of the invention. Referring to FIG. 5, in the waveform diagram of the sound signal 50 of the present embodiment, a horizontal axis represents time, and a vertical axis represents voltages obtained by a microphone when measuring the sound signal 50, which reflects an intensity of the sound signal 50. In the present embodiment, it is determined whether the waveform of the sound signal 50 reaches peaks (i.e. the peaks S1-S11), and when the sound signal 50 reaches each peak of the waveform, the light produced by the light source is controlled to transform color between the colors corresponding to different tones, for example, to transform color between red corresponding to the guitar and green corresponding to the French horn, so as to increase the feeling of the user on the sound effect of the two musical instruments.

Besides adjusting the color of the light produced by the light source according to the tones, in another embodiment, the acousto-optic effect producing apparatus can also adjust the color of the light produced by the light source according to a frequency of the sound variation. Another embodiment is provided below for descriptions.

FIG. 6 is a block diagram of an apparatus for producing situational acousto-optic effect according to an embodiment of the invention. Referring to FIG. 6, the acousto-optic effect producing apparatus 60 is, for example, an electronic apparatus having a basic computing capability such as a mobile phone, a tablet PC, a notebook computer, a video player, or a sound system. The acousto-optic effect producing apparatus 60 includes a sound detection module 62, a determination module 64 and a light control module 66. The aforementioned modules are, for example, hardware devices composed of logic circuit elements, and are capable of executing a function of producing the situational acousto-optic effect. The aforementioned modules can also be programs stored in a storage medium of the electronic apparatus, and the programs can be loaded to a processor of the electronic apparatus to execute the function of producing the situational acousto-optic effect.

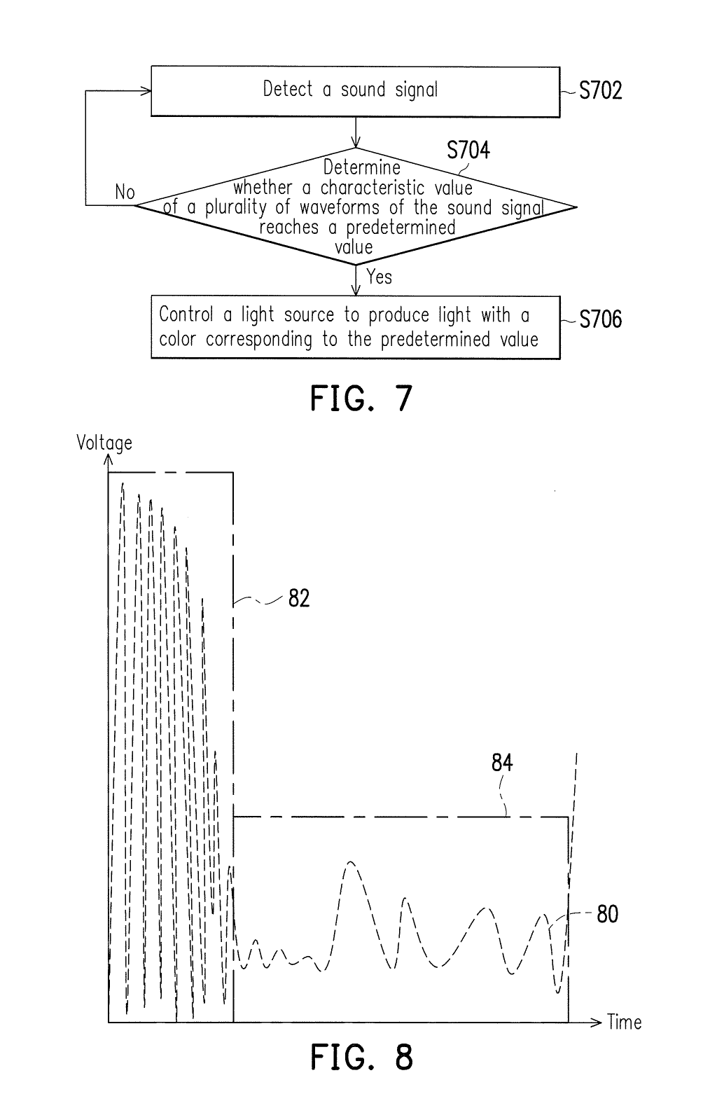

FIG. 7 is a flowchart illustrating a method for producing situational acousto-optic effect according to an embodiment of the invention. Referring to FIG. 6 and FIG. 7, the method of the present embodiment is adapted to the acousto-optic effect producing apparatus 60, and detailed steps of the method of the present embodiment are described below with reference of various components of the acousto-optic effect producing apparatus 60 of FIG. 7.

First, the sound detection module 62 detects a sound signal (step S702), where the sound detection module 62, for example, detects an ambient sound of the acousto-optic effect producing apparatus 60 by using a microphone of the acousto-optic effect producing apparatus 60 to produce the sound signal.

Then, the determination module 64 determines whether a characteristic value of a plurality of waveforms of the sound signal reaches a predetermined value (step S704). When the determination module 64 determines that the characteristic value of the waveforms does not reach the predetermined value, the flow returns to the step S702, and the sound detection module 12 continually detects the sound signal. When the determination module 64 determines that the characteristic value reaches the predetermined value, the light control module 66 controls the light source to produce light with a color corresponding to the predetermined value (S706). The light control module 66 is, for example, coupled to a plurality of light sources through a wired manner or a wireless manner, and controls the light sources to produce light with a color corresponding to the predetermined value according to a determination result of the determination module 64.

In detail, in an embodiment, the characteristic value is an oscillation frequency of the waveforms of the sound signal, and the acousto-optic effect producing apparatus 60 further includes a color setting module (not shown). The color setting module detects a maximum value and a minimum value of the oscillation frequency of the waveforms of the sound signal, divides a section between the minimum value and the maximum value into a plurality of predetermined values, and sets a corresponding color of light for each of the predetermined values. The color setting module, for example, sets the color of the light corresponding to the minimum value to purple, sets the color of the light corresponding to the maximum value to red, and sequentially sets the color of the light corresponding to each of the predetermined values in the section between the minimum value and the maximum value to other colors between purple and red. For example, the color setting module, for example, divides the section between the minimum value and the maximum value into seven equal parts, and sequentially sets the colors of the light corresponding to each of the predetermined values in the section between the minimum value and the maximum value to red, orange, yellow, green, blue, indigo and purple. In this way, each time when the determination module 64 determines that the characteristic value reaches any one of the predetermined values, the light control module 66 controls the light sources to produce the light with a color corresponding to the predetermined value. When the sound variation is relatively intense, the light sources produce the light with a color close to the red zone, and when the sound variation is relatively smooth, the light sources produce the light with a color close to the purple zone. In this way, the color of the light produced by the light sources can reflect a rhythm of the sound.

For example, FIG. 8 is a waveform diagram of a sound signal according to an embodiment of the invention. Referring to FIG. 8, in the waveform diagram of the sound signal 80 of the present embodiment, a horizontal axis represents time, and a vertical axis represents voltages obtained by a microphone when measuring the sound signal 80, which reflects an intensity of the sound signal 80. In the present embodiment, it is determined whether the oscillation frequency of each waveform of the sound signal 80 reaches a predetermined value, and when the oscillation frequency of each waveform of the sound signal 80 reaches the predetermined value, the light source is controlled to produce light with a color corresponding to the predetermined value. For example, when the sound variation is relatively intense (for example, a sound signal 82), the light source produce the light with a color close to the red zone, and when the sound variation is relatively smooth (for example, a sound signal 84), the light source produce the light with a color close to the purple zone.

In another embodiment, the characteristic value is an amplitude of the sound signal, and the determination module 64 determines whether the amplitude of each waveform of the sound signal reaches a peak, and when the determination module 64 determines that the amplitude of each waveform reaches the peak, the light control module 66 controls the light source to transform the color of the light. Taking the sound signal 50 of FIG. 5 as an example, each time when the amplitude of each waveform of the sound signal 50 reaches the peak, the acousto-optic effect producing apparatus controls the light source to change the color of the light. The acousto-optic effect producing apparatus, for example, respectively sets red, orange, yellow, green, blue, indigo and purple to values of 1-7, and when the amplitude of each waveform of the sound signal 50 reaches the peak, the acousto-optic effect producing apparatus randomly generates a value between 1 and 7, and controls the light source to change the color of the light to the color corresponding to the value. If the color corresponding to the value generated by the acousto-optic effect producing apparatus is the same as a current color, a next value is regenerated. According to the above method of changing the color of the light when the sound signal reaches the peak, the user may obviously feel the rhythm of the sound, so that the acousto-optic effect is increased.

In summary, in the method and apparatus for producing situational acousto-optic effect, the frequencies and rhythm of the sound signal are analyzed to detect characteristics of tone, emotion, etc. carried by the sound signal, so as to control the light source to produce the light with a color corresponding to the characteristics. In this way, the light with the color fitting in with the sound situation can be generated, so as to provide an acousto-optic effect with sound and light harmonized to each other.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for producing situational acousto-optic effect, adapted to an electronic apparatus, comprising:
detecting a sound signal;
performing a fast Fourier transform and a normalization calculation on the sound signal to produce a frequency domain signal;
determining whether a plurality of frequencies having variations between the frequency domain signals produced before and after a time point fit in with a frequency spectrum of a specific tone; and
controlling a light source to produce light with a color corresponding to the specific tone once the frequencies fit in with the frequency spectrum of the specific tone.

2. The method for producing situational acousto-optic effect as claimed in claim 1, wherein the step of determining whether the frequencies having variations between the frequency domain signals produced before and after the time point fit in with the frequency spectrum of the specific tone comprises:
respectively comparing the frequencies having the variations with a plurality of characteristic frequencies in the frequency spectrum of each of a plurality of tones; and
determining that the frequencies fit in with the frequency spectrum of the specific tone when the frequencies exactly fit in with the characteristic frequencies in the frequency spectrum of the specific tone.

3. The method for producing situational acousto-optic effect as claimed in claim 1, wherein when the frequencies fit in with the frequency spectrum of the specific tone, the method further comprises:
continually detecting the sound signal;
performing the fast Fourier transform and the normalization calculation on the sound signal to produce the frequency domain signal;
determining whether a plurality of frequencies having variations between the frequency domain signals produced before and after a next time point fit in with the frequency spectrum of another specific tone;
controlling the light source to produce the light with a color corresponding to the another specific tone once the frequencies fit in with the frequency spectrum of the another specific tone.

4. The method for producing situational acousto-optic effect as claimed in claim 3, wherein after the step of controlling the light source to produce the light with the color corresponding to the another specific tone, the method further comprises:
controlling the light produced by the light source to transform between the color corresponding to the specific tone and the color corresponding to the another specific tone when each waveform of the sound signal reaches a peak.

5. The method for producing situational acousto-optic effect as claimed in claim 1, wherein the specific tone comprises a tone of a sound producing object, and the sound producing object comprises a human, an animal, or a musical instrument.

6. A method for producing situational acousto-optic effect, adapted to an electronic apparatus, comprising:
detecting a sound signal;
determining whether a characteristic value of a plurality of waveforms of the sound signal reaches a predetermined value; and
controlling the light source to produce light with a color corresponding to the predetermined value when the characteristic value of the waveforms reaches the predetermined value.

7. The method for producing situational acousto-optic effect as claimed in claim 6, wherein the characteristic value is an oscillation frequency of the waveforms, and before the step of determining whether the characteristic value of the waveforms of the sound signal reaches the predetermined value, the method further comprises:
detecting a maximum value and a minimum value of the characteristic value of the waveforms of the sound signal; and
dividing a section between the minimum value and the maximum value into a plurality of predetermined values, and setting a corresponding color of the light for each of the predetermined values.

8. The method for producing situational acousto-optic effect as claimed in claim 7, wherein the step of dividing the section between the minimum value and the maximum value into the predetermined values and setting the corresponding color of the light for each of the predetermined values comprises:
setting the color of the light corresponding to the minimum value to purple, and setting the color of the light corresponding to the maximum value to red; and
sequentially setting the color of the light corresponding to each of the predetermined values in the section between the minimum value and the maximum value to other colors between purple and red.

9. The method for producing situational acousto-optic effect as claimed in claim 6, wherein the characteristic value is an amplitude of each of the waveforms, and the step of determining whether the characteristic value of the waveforms of the sound signal reaches the predetermined value, so as to control the light source to produce the light with the color corresponding to the predetermined value comprises:
determining whether the characteristic value of each waveform of the sound signal reaches a peak; and
controlling the light source to transform the color of the light when the characteristic value of each waveform of the sound signal reaches the peak.

10. An apparatus for producing situational acousto-optic effect, comprising:
a sound detection module, detecting a sound signal;
a signal transformation module, performing a fast Fourier transform and a normalization calculation on the sound signal detected by the sound detection module to produce a frequency domain signal;
a determination module, deter mining whether a plurality of frequencies having variations between the frequency domain signals produced before and after a time point fit in with a frequency spectrum of a specific tone; and
a light control module, controlling a light source to produce light with a color corresponding to the specific tone when the determination module determines that the frequencies fit in with the frequency spectrum of the specific tone.

11. The apparatus for producing situational acousto-optic effect as claimed in claim 10, wherein the determination module respectively compares the frequencies having the variations with a plurality of characteristic frequencies in the frequency spectrum of each of a plurality of tones, and when the frequencies exactly fit in with the characteristic frequencies in the frequency spectrum of the specific tone, the determination module determines that the frequencies fit in with the frequency spectrum of the specific tone.

12. The apparatus for producing situational acousto-optic effect as claimed in claim 10, wherein the determination module determines whether a plurality of frequencies having variations between the frequency domain signals produced before and after a next time point fit in with the frequency spectrum of another specific tone, and when the determination module determines that the frequencies fit in with the frequency spectrum of the another specific tone, the light control module controls the light source to produce the light with a color corresponding to the another specific tone.

13. The apparatus for producing situational acousto-optic effect as claimed in claim 12, wherein the light control module further controls the light source to transform the light between the color corresponding to the specific tone and the color corresponding to the another specific tone when each waveform of the sound signal reaches a peak.

14. The apparatus for producing situational acousto-optic effect as claimed in claim 10, wherein the specific tone comprises a tone of a sound producing object, and the sound producing object comprises a human, an animal, or a musical instrument.

15. An apparatus for producing situational acousto-optic effect, comprising:
a sound detection module, detecting a sound signal;
a determination module, determining whether a characteristic value of a plurality of waveform is of the sound signal reaches a predetermined value; and
a light control module, controlling the light source to produce light with a color corresponding to the predetermined value when the determination module determines that the characteristic value of the waveforms reaches the predetermined value.

16. The apparatus for producing situational acousto-optic effect as claimed in claim 15, wherein the characteristic value is an oscillation frequency of the waveforms, and the apparatus further comprises:
a color setting module, detecting a maximum value and a minimum value of the characteristic value of the waveforms of the sound signal, and dividing a section between the minimum value and the maximum value into a plurality of predetermined values, and setting a corresponding color of the light for each of the predetermined values.

17. The apparatus for producing situational acousto-optic effect as claimed in claim 16, wherein the color setting module sets the color of the light corresponding to the minimum value to purple, sets the color of the light corresponding to the maximum value to red, and sequentially sets the color of the light corresponding to each of the predetermined values in the section between the minimum value and the maximum value to other colors between purple and red.

18. The apparatus for producing situational acousto-optic effect as claimed in claim 15, wherein the characteristic value is an amplitude of each of the waveforms, and the determination module determines whether the characteristic value of each waveform of the sound signal reaches a peak, and the light control module controls the light source to transform the color of the light when the determination module determines that the characteristic value of each waveform of the sound signal reaches the peak.
